(19) United States
(12) Patent Application Publication
(10) Pub. No.: US 2006/0134770 A1
(43) Pub. Date: Jun. 22, 2006

(54) Microorganisms for assimilating oils or fats, etc. and methods for treating waste liquids and deodorizing by using the same

(75) Inventor: Norio Miyako, Oita-shi (JP)

Correspondence Address: JORDAN AND HAMBURG LLP, 122 EAST 42ND STREET, SUITE 4000, NEW YORK, NY, 10168, US

(73) Assignee: Kanbiken Kabushiki Kaisha, Oita-shi (JP)

(21) Appl. No.: 11/175,499

(22) Filed: Jul. 5, 2005

(30) Foreign Application Priority Data
Dec. 20, 2004 (JP) 2004-367526

(51) Int. Cl. B09C 1/10

(52) U.S. Cl. 435/262.5

(57) ABSTRACT

The microorganisms for assimilating oils, fats or an organic waste material, etc. according to the present invention can efficiently decompose waste oils, fats or organic waste materials, etc. contained in a waste liquid and reduce concentrations of such waste oils, fats or organic waste materials, etc. to a level lower than a given standard level. The microorganisms for assimilating waste oils, fats or organic waste materials, etc. to be used for the present invention include strains belonging to genus Sphingomonas, genus Nocardia, genus Microbacterium or genus Bacillus or a mixture of the strains belonging to genera Sphingomonas, Nocardia, Microbacterium and/or Bacillus. The present invention is further directed to a method for treating waste liquids containing waste oils, fats or organic waste materials, etc. by using the microorganisms for assimilating oils, fats or organic waste materials, etc. or to a method for deodorizing offensive odors resulting from such waste liquids.

### FIELD OF THE INVENTION

The present invention relates to a microorganism for assimilating oils, fats, or an organic waste material, etc., capable of efficiently decomposing waste oils, fats, or an organic waste material, etc., contained in a waste liquid, without adversely affecting environment and human bodies, and to methods for treating a waste liquid discharged from facilities or kitchens of restaurants, diners, hotels, food or cooking centers, hospitals, or the like and to methods for deodorizing offensive odors or the like derived from such a waste liquid by using the same. More particularly, the present invention relates to a microorganism for assimilating oils, fats, or an organic waste material, etc. capable of efficiently decomposing a waste oils or fats or an organic waste material, etc. contained in a waste liquid discharged therefrom, and/or n-hexane extracts in high concentrations in such a waste liquid as well as to methods for treating a waste liquid discharged therefrom and for deodorizing offensive odors, etc. from such a waste liquid.

### RELATED ART

Recent years, quantities of natural organic waste materials are increasing to a great extent as human activities make progress resulting in development of industry and economy as well as changes of ways of nutritional living, etc. In particular, consumption of livestock products is explosively growing as ways of nutritional living are changed toward a life style in which more animal foods are consumed. As the consumption of livestock products increases, waste liquids containing large quantities of waste oils or fats, etc. are caused to increase as a matter of course. In particular, large amounts of waste oils, fats or oily or greasy materials, etc. are discharged as waste liquids, for example, from facilities or kitchens of restaurants, diners, hotels, food or cooking centers, hospitals, or the like. As a result, waste liquids discharged from such facilities and so on naturally contain large quantities of waste oils or fats, etc.

Generally, waste oils, fats or the like contaminated in waste liquids have so far been treated, for example, by conventional ways such as, e.g., throwing away into rivers or sea or burning. Such marine disposal of waste liquids, however, may become a cause of pollution of rivers, sea or the like due to contamination of waste oils, fats or the like and malodors generated from waste oils, fats or the like, resulting in a matter of social problems. Nowadays, therefore, marine disposal of waste liquids are prohibited by the law in order to prevent rivers and sea from pollution and preserve a marine environment. On the other hand, treatment or disposal of waste liquids by burning waste oils or fats, etc. contained therein also becomes a cause of atmospheric pollution, resulting in an occurrence of environmental destruction and as a consequence causing an object of social concern. Moreover, the disposal by burning waste oils, fats, etc. becomes serious social problems from the viewpoint of discharge of carbonic acid gas that is one of great causative materials of climate change. Therefore, there is an urgent need for development of methods for effectively treating waste oils or fats, etc., which does not cause any environmental destruction or can reduce environmental pollution as much as possible.

A large quantity of waste liquids containing waste oils or fats, etc. is also discharged as sewage from houses. In cities or the like where sewage disposal plants are built to a sufficient extent, sewage containing waste liquids or the like can be discharged into rivers and sea after waste oils, etc. have been treated and decomposed to an appropriate extent by the sewage disposal plants. Currently, however, the disposal of sewage containing the waste liquids requires an enormous amount of expenses and increases a heavily economic burden on the authorities in charge of sewage disposal plants and so on. In other areas where sewage disposal plants are little or not built, on the other hand, large quantities of waste liquids containing waste oils or fats, etc. are discharged as domestic sewage directly into rivers or sea, etc. without previous treatment or disposal of the waste liquids to such a satisfactory extent as being allowed to be adapted to throwing away into rivers or sea, etc. This may result in a great cause of pollution and contamination of rivers or sea, etc. and as a consequence causing an environmental destruction.

Disposal of waste oils, fats or organic waste materials, etc. contained in sewage or the like with no or little pre-treatment may also cause a different problem. The waste oils or fats, etc. of the waste liquids may decrease a temperature of sewage, thereby causing the oils or fats, etc. to become solidified as the temperature of the sewage decreases below the solidification point of the oils or fats, etc., and causing the solidified oils or fats, etc. to be attached to inner surfaces of drain pipes, etc., thereby clogging the drain pipes, etc. In particular, in sewage disposal plants, a considerably large amount of expenses is additionally required for maintenance and management of drainpipes, etc.

In order to solve the serious problems as described above, facilities or kitchens, etc., of restaurants, diners, hotels, supermarkets, hospitals, etc. have now been placed under an obligation of the provision of a grease trap which works as a collector of waste oils or fats, etc. contained in waste liquids before discharging the waste liquids into drain pipes. The grease trap can also work as a reservoir vessel which may be provided with an inlet and an outlet, the inlet being disposed through which drainage discharged from facilities kitchens can flow into the grease trap and the outlet being disposed through which the drainage in the grease trap can be discharged into drainpipes or tanks for separating solid materials from the waste liquids. The grease trap may further be provided with the structure which may be arranged such that a container is divided into three or four sections in order to allow the waste liquids to stay in the container for the elongated residence period of time, thereby permitting the waste oils or fats, etc. contained in the drainage to be readily trapped by the grease trap. It can be noted herein, however, that the grease trap holds the physical function for separating and collecting waste oils or fats, etc. from drainage, but it has no function of biologically or chemically decomposing the waste oils or fats, etc. contained in waste liquids.

The waste oils or fats, etc. separated from the sewage and accumulated by the grease trap in the manner as described above have to be collected and removed from the grease trap at periodical intervals and then treated in an appropriate way. These waste matters collected in the above manner have so far been destroyed by burning at industrial waste disposal locations. The industrial waste disposal locations throughout the country, however, have almost reached their limits of treatment or disposal. Furthermore, the construction of new industrial waste disposal locations is almost impossible due to objections to destruction of environment or for other reasons. Under current circumstances, therefore, illegal disposal of waste liquids including throwing away waste oils or fats, etc. into rivers, seas, etc. have often been made. This also becomes an object of public concern.

In order to solve the problems with disposal of waste liquids or waste oils, fats or organic waste materials, etc. by burning or throwing off into rivers or sea, chemical waste treatment processes and biological waste treatment processes have been proposed as alternatives for the conventional disposal methods as illustrated above. At the present time, however, each of the chemical and biological treatment processes cannot be considered to reach a practically applicable technology level yet. It is to be understood herein that, on the one hand, the chemical waste treatment is the process for treating or processing waste oils, fats or organic waste materials, etc., contained in waste liquids, for example, by decomposing such waste oils or fats or the like with a chemical agent and that, on the other hand, the biological waste treatment is the process for treating or processing such waste oils or fats or the like, for example, by decomposing such waste liquids with a microorganism capable of assimilating oils or fats, etc. or a mixture of such microorganisms.

As the chemical waste treatment processes, there may be reported, for example, processes which use a waste disposal agent containing, as active components, for example, saponin and an alkyl glycoside such as, e.g., hexyl glycoside, hexyl galactoside, hexyl mannoside, isohexyl glycoside or the like (Japanese Patent Application Publication No. 7-24,454); water-adsorptive polymers such as, e.g., starch-acrylic acid graft polymers, cellulose-acrylic acid graft polymers, or acrylic polymers such as, e.g., polyacrylic acids or sodium salts thereof, polyacrylamides, polymethacrylic acids or sodium salts thereof, or the like, or cationic polymers such as, e.g., aminoalkyl (meth)acrylate quaternary salt polymers, polyaminomethyl acrylamide salts or quaternary salt polymers, chitosan acetate, polyamine sulfones, polyacrylamine hydrochloride salts, or the like (Japanese Patent Application Publication No. 7-188,647); and agents for treating a waste liquid containing oils or fats, etc., comprising a mixture of three surfactants, i.e., a polyoxyethylene alkyl ether sulfate ester sodium salts as an anionic surfactant, a fatty acid diethanol amide as a nonionic surfactant, and a polyethylene alkyl ether (Japanese Patent Application Publication No. 2004-277,550).

As microorganisms to be used for the biological waste treatment processes, there may be reported various organisms such as, for example, a large number of strains belonging to genus Cryptococcus (Japanese Patent Application Publication No. 11-244,892); genus Acinetobacter (Japanese Patent Application Publication No. 2003-24,051 and No. 11-196,861); genus Bacillus (Japanese Patent Application Publication No. 2003-228); genus Burkholderia (Japanese Patent Application Publication No. 2002-125,659); genus Staphylococcus (Japanese Patent Application Publication No. 2000-228,977); genus Pseudomonas (Japanese Patent Application Publication No. 2000-270,845 and No. 2003-116,526); and genus Aspergillus (Japanese Patent Application Publication No. 2003-235,465). Each of the techniques using these organisms, disclosed in the prior art, can decompose oils or fats, etc. present in waste liquids when used singly, however, the ability of each of the organisms for decomposing the waste oils or fats, etc. cannot be said to be sufficient enough and at the same time they cannot efficiently reduce the organic wastes to a level lower than a given exhaust level. Therefore, there is still a room for improvement in those processes by using new types of microorganisms or a mixture thereof.

There is another proposal for using a lipase for the biological waste treatment processes, which is an enzyme having the ability to decompose oils or fats, etc. As such lipases, there may be used, for example, one derived from animals or plants as well as commercially available microorganism-derived ones. Among the organism-derived lipases, there may also be used ones derived from organisms including, but being not limited to, genus Rhizopus, Aspergillus, Mucor, Pseudomonas, Geotrichum, Penicillium or Candida (Japanese Patent Application Publication No. 2004-113,238).

In order to solve the problems prevailing in the prior art technology relating to disposal of waste liquids containing waste oils or fats, etc., the present inventors have already succeeded in identifying particular microorganisms which can grow in waste liquids containing waste materials by assimilating waste oils or fats, etc. The inventors have identified those microorganisms as strains belonging to Sphingomonas sp., Microbacterium saperdae and Microbacterium esteraromaticum, and Bacillus cereus, and proposed the method for decomposing organic waste materials by utilizing a mixture of those microorganisms (Japanese Patent No. 3,400,418) as a more useful treatment than a single use of those organisms. It has been found, however, that this method for decomposing organic waste materials with the mixture of the microorganisms still has a room to be improved further.

It has further been noted herein that waste liquids discharged particularly from cooking facilities or kitchens, etc., of restaurants, diners, hotels, food centers, hospitals and so on have various characteristics which may vary in a multi-functional way. In order to efficiently treat such multi-functional waste liquids, therefore, it is now found necessary to provide a new mixture of microorganisms which can be adapted to various characteristics of waste liquids. For example, Table 1 below shows statistics of BOD values and amounts of n-hexane extracts in waste liquids from facilities or the like discharging waste liquids in the amount of 50 tons or less per day (Statistical Data from The Ministry of Environment: Year 2003).

TABLE 1
BOD values and amounts of n-hexane extracts in
waste liquids from different facilities

| | BOD Values | n-hexane extracts |
|---|---|---|
| Facilities | (mg/liter) | (mg/liter) |
| Food-cooking centers | 40-1,700 | 10-1,200 |
| Chinese restaurants | 30-3,400 | 12-2,200 |
| Buck-wheat noodle shops | 210-1,200 | 10-250 |
| Japanese restaurants | 50-2,600 | 5-780 |
| (Sewage drain standard | (less than 300) | (less than 30) |
| level) | | |

As is apparent from the results of Table 1 above, waste liquids discharged from various facilities and kitchens, etc. contain very large and different amounts of n-hexane extracts and have high BOD values so that they are very likely to cause problems with offensive odors and so on. In order to treat various waste liquids with causing no or little problems, it is needed to efficiently decompose the waste oils, fats or organic waste materials, etc. contained in waste liquids and reduce the BOD value as well as to treat the waste liquids in situ at a place located as close as possible to a source of causing an occurrence of offensive odors or the like. Therefore, in order to solve the problems with disposal of waste liquids, development of a new type mixture of microorganisms may become a great help, which can dispose pollution in the grease trap at a place closer to a source of causing an occurrence of pollution and so on.

A combined disposal tank for treating waste liquids containing waste oils or fats, etc. sometimes may not treat organic materials present in waste liquids to a sufficient extent and discharge the waste liquids in an inadequately treated state into public drains. This causes the problem that may impose an excessive burden on public sewage disposal plants. In this respect, too, a new type mixture of microorganisms capable of treating waste oils, fats, etc. contained in waste liquids at a location closer to a source of an occurrence of malodors, etc. may become an effective tool for solving the problems as described above. Therefore, development of such a microorganism mixture is of great assistance.

In addition, it can be noted that a constant occurrence of offensive odors or the like due to an ineffective treatment of waste oils or fats, etc. by the grease traps or organic materials in the combined disposal tanks, etc. may become an object of public concern. It is the state of a current situation, however, that treatment of offensive odors, etc. is not yet carried out to an adequate extent at various cooking facilities of restaurants, food shops and so on. Therefore, it is of great importance in treatment of waste liquids to develop a mixture of microorganisms capable of deodorizing offensive odors, etc.

As described above, disposal of waste liquids may impose a heavily financial burden in particular on small-scale facilities or kitchens, etc. of restaurants, diners, hotels, cooking or food centers, hospitals or the like, so that it may be anticipated in many cases to be financially difficult for such small-scale facilities or kitchens, etc. to build large-scale waste disposal equipment. Moreover, waste liquids are sometimes discharged illegally without being treated to a sufficient extent. In other words, current issues to be solved in waste disposal lie in a heap. In these respects, too, development of new type microorganisms and methods for treating waste liquids containing waste oils, fats or organic waste materials and for deodorizing malodors, etc. generated therefrom is of great importance and it is a great contribution to preservation of natural environment.

### SUMMARY OF THE INVENTION

Given the situation as described above, the present inventors have conducted further extensive studies and research to solve the various difficulties and problems involved in the prior art technology as described above and to develop their own technology using a mixture of the new microorganisms as described above. As a result, it is now found that some new strains of microorganisms can decompose a waste liquid including waste oils or fats, etc. and high concentrations of an organic waste material in the waste liquid having various characteristics as described above. It is further found that a mixture of such new strains of microorganisms with each other or with other known strains of microorganisms can efficiently decompose the waste oils and organic waste materials. Moreover, it is found that a culture mixture of the microorganisms can deodorize offensive odors resulting from decay or rotting of waste oils or fats, etc. contained therein and that a deodorizing microorganism preparation can be formulated. The present invention has been completed on the basis of these findings.

Therefore, the present invention has the object to provide a microorganism for assimilating oils, fats or organic waste materials, etc. or a mixture of such microorganisms, which is capable of efficiently and readily decomposing waste oils, fats or organic waste materials, etc., contained in a waste liquid even in high concentrations without adversely affecting environment and human bodies. The present invention has another object to provide a method for treating such waste liquids by using the microorganism or the mixture of the microorganisms and to provide a method for deodorizing offensive odors or the like resulting from diner facilities or kitchens, etc. by using the microorganism or the mixture of the microorganisms. The microorganism or the mixture of the microorganisms, and the method for treating the waste liquids and the other objects according to the present invention can efficiently remove waste oils, fats or organic waste materials, etc. from a waste liquid even in high concentrations. Moreover, the method for deodorizing malodors and so on from such waste liquids can efficiently remove offensive odors, etc. from cooking facilities or kitchens, toilets, pet sewage equipment, and so on.

Therefore, the microorganism and the mixture of the microorganisms according to the present invention can reduce an amount of the waste oils or fats, etc., contained in a waste liquid, when incubated in a culture medium containing the waste oils or fats, etc., thereby reducing a degree of pollution or offensive odors, etc. and finally removing it.

Now, terminology used in this specification will be described in more detail. It is to be noted herein, however, that the terminology as used herein should not in any respect be interpreted as being limited to a particular meaning as will be used in the description below and it should be understood that it is used solely for illustrative purposes for brevity of explanation. Moreover, it should be noted herein that the terminology as used herein is used without excluding generic meanings derived from the terms themselves.

As used herein, the terms “waste liquid” and related terms are intended in a generic term to refer to a liquid that contains waste oils, fats or any other oily or greasy matter derived in particular as a result of cooking or disposing particularly animal-derived foods and so on or treating greases for machines and so on. The terms “oils” and “fats” as used herein are intended to refer to a fatty acid, a glycerin ester thereof or an animal- or plant-derived organic oily substance containing the same or a denatured oil produced as a result of denaturing a cooking oil by cooking or by any other means. It can be understood, accordingly, that, when either one of the terms is used in this description, it should be interpreted as encompassing the meaning of the other, too. The terms “waste oils” and “waste liquids containing oils or fats” and related terms as used herein are intended to refer to waste liquids, etc. containing waste oils or fats, etc. and to drainage or sewage containing the waste oils, respectively. As used herein, the terms “organic waste material(s)” is or are intended to refer to a waste material with an organic material including, or being not limited to, a waste liquid discharged from facilities, kitchens or the like. The term “assimilating” is intended herein to refer to the action of cleaning waste oils, fats or organic waste materials, etc., the action referring to decomposition or anabolism of waste oils, fats or organic waste materials, etc. contained in a waste liquid, etc. Further, the terms “facilities” or “kitchens” or related terms as used herein are intended to refer to a cooking facility, kitchen or any place including, but being not limited to, restaurants, cuisine, diners, hotels, cooking or food centers, supermarkets, hospitals, food processing factory, disposal equipment, animal feeding facilities, private houses, or the like, where livestock foods or oils or fats, etc. or any other oily or greasy materials are cooked, treated or disposed and waste liquids are derived as a result of cooking, treatment, disposal or the like. The terms “sewage” and “drainage” as used herein refer to any waste liquid to be discharged from the facilities or kitchens, etc., as household or domestic waste or industrial waste, etc. Moreover, the terms “offensive odors” or “malodors” are intended herein to refer to unpleasant odors which are to be generated from anything that produces and generates an unpleasant feeling to a person, which may include, but be not limited to, kitchens, drains, waste disposal plants, rooms and houses conducting various business, animals including pets, and so on.

In order to achieve the object, as the first aspect, the present invention provides a microorganism for assimilating oils, fats or organic waste materials, etc. contained in a waste liquid, which is capable of decomposing the waste oils, fats, or organic waste materials, etc. contained in the waste liquid. In another aspect, it provides a mixture of such microorganisms for assimilating oils or fats, etc., capable of decomposing the waste oils, fats or organic waste materials, etc. contained therein. The present invention further provides a method for treating waste liquids by using the microorganism or the mixture of the microorganisms capable of assimilating the same. The present invention as a still further aspect provides a method for decomposing waste oils, fats or organic waste materials, etc. up to approximately 7% by volume with respect to the total volume of a disposal vessel by using the microorganism or the mixture of the microorganisms and a disposal vessel. In a still further aspect of the present invention, there is provided a method for decomposing waste oils, fats or organic waste materials, etc. contained in a waste liquid in lower concentrations than the above level in drainage or sewage discharged from facilities or kitchens, etc. by utilizing the microorganism or the mixture of the microorganisms and the grease trap and discharging the drainage or sewage to drainpipes or the like at a given waste drain standard level. Moreover, the present invention as still further aspects provides a deodorizing agent for removing offensive odors from facilities or kitchens and a method for removing offensive odors.

More particularly, the present invention further has the major object to provide a microorganism for assimilating oils, fats or organic waste materials, etc. contained in a waste liquid, which belongs to genus Sphingomonas and comprises a strain of Sphingomonas sp. capable of growing in such a waste liquid by assimilating the waste oils, fats or organic waste materials, etc. contained therein. In another embodiment, the present invention has the object to provide a microorganism for assimilating the oils, fats or organic waste materials, etc., belonging to genus Nocardia capable of growing in the waste liquid by assimilating the waste oils or fats, etc. contained therein.

In another aspect, the present invention also has another object to provide a mixture of the microorganisms capable of assimilating oils, fats or organic waste materials, etc., contained in a waste liquid, which belong to genus Nocardia capable of growing in the waste liquid by assimilating the waste oils or fats, etc., to genus Sphingomonas capable of growing in the waste liquid by assimilating the waste oils or fats, etc., and/or genus Microbacterium capable of growing in the waste liquid by assimilating waste oils or fats, etc., and/or genus Bacillus capable of growing in the waste liquid by assimilating the waste oils or fats, etc.

In a further aspect, the present invention has an object to provide a method for treating waste liquids which can decompose waste oils, fats or organic waste materials, etc., contained in the waste liquids, by using the microorganism for assimilating oils, fats or organic waste materials, etc. or the mixture of the microorganisms capable of assimilating the waste oils or fats, etc., contained therein. In still further aspects, the present invention has objects to provide a microorganism preparation comprising the microorganism for assimilating oils, fats or an organic waster material, etc. contained in the waste liquid, which is appropriate for use in treating the waste liquid, and to provide such a microorganism preparation for use in deodorizing offensive odors, etc. and to provide methods for treating waste liquids and for deodorizing malodors, etc. by using the respective microorganism preparations.

In order to further achieve the object of the present invention, as an embodiment, there is provided a particular strain belonging to genus Sphingomonas and capable of growing by assimilating waste liquids such as oils, fats or organic waste materials, etc. contained in the waste liquid. The present invention as another embodiment further provides a microorganism for assimilating oils or fats belonging to genus Nocardia capable of growing in the waste liquid by assimilating waste oils, fats or organic waste materials, etc. contained in the waste liquid. Moreover, as another embodiment, the present invention provides a strain of a microorganism for assimilating oils, fats or organic waste materials, etc., belonging to genus Nocardia and growing in the waste liquid by assimilating the waste oils or fats, etc.

As a still further embodiment, the present invention provides a mixture of microorganisms for assimilating oils, fats or organic waste materials, etc., contained in a waste liquid, which comprise microorganisms belonging to genus Nocardia and genus Sphingomonas and/or genus Microbacterium and/or genus Bacillus, each capable of growing in the waste liquid by assimilating the waste oils, fats or organic waste materials, etc. contained in the waste liquid. Moreover, the present invention, as a preferred embodiment, provides a mixture of microorganisms comprising strains belonging to each of the genera capable of assimilating the waste oils, fats or organic waste materials, etc. and growing in a medium containing the same.

### BEST MODES FOR CARRYING OUT THE INVENTION

The present invention comprises a new microorganism for assimilating oils or fats, etc. capable of decomposing waste oils, fats or an organic waste material, etc., contained in a waste liquid, which belongs to Sphingomonas sp. or Nocardia sp. Further, the present invention comprises a mixture of the microorganism for assimilating the waste oils or fats or organic waste materials, etc., contained therein, the microorganisms belonging to genus Nocardia with at least one of microorganisms for assimilating oils or fats, etc., which belong to genera Sphingomonas, Microbacterium and Bacillus.

The new microorganisms for assimilating oils, fats or an organic waste material, etc. according to the present invention are selected from a group of the microorganisms for assimilating oils or fats, etc., which can assimilate the waste oils, fats or an organic waste material, etc. contained in a waste liquid and grow in such a waste liquid under such critical circumstances as continually incubating the waste liquid in a broth liquid medium to multiply cells of the strain and further incubating the multiplied strain cells in a liquid medium to which the waste liquid containing the waste oils, fats or the organic materials, etc. is to be added. In order to permit an effective selection of the microorganisms separated from a soil sample, a selection medium has been devised for a selection of microorganisms from soil bacteria, which can efficiently decompose oils, fats or the organic waste materials, etc. contained in the waste liquid. Moreover, as a result of extensive review and studies, a composition of the selection medium has been formulated so as to provide a medium formulation having a composition close to contents of a discharge from a kitchen or the like. Such a selection medium has been prepared by devising a medium that uses a hot water extract of a fish meat and a pork meat (50 grams/liter) without addition of sugar components and other components. In the event where the sugar component is added, the medium becomes likely to be contaminated with foreign organisms. If the medium would be contaminated with foreign organisms, the foreign organisms promulgate to a great extent and cause no producing useful microorganisms. A group of the microorganisms which hold the stable ability of efficiently decomposing waste oils or fats, etc. has been selected by a continual incubation for a long period of time at room temperature under aerobic conditions where oxygen has been added to the medium in an excessive amount. Further, surprisingly, it has been found that a mixed culture of such microorganisms has the ability of deodorizing offensive odors and so on derived from waste oils or fats, etc., so that a deodorizing preparation comprising the microorganism or a mixture of the microorganisms can be formulated which is capable of deodorizing offensive odors, etc. derived from the waste oils or fats, etc. contained in the waste liquid.

The microorganisms for assimilating oils or fats, etc. according to the present invention have been separated each from a mixed culture from a variety of microorganisms and classified in accordance with “Bergey's Manual of Systematic Bacteriology, 8th Edition”, and the strains have been identified by determination of partial base sequences of their 16SrDNAs. As a result, the microorganisms in accordance with the present invention are determined as new strains belonging to genus Sphingomonas and genus Nocardia, respectively. In other words, they are identified as Sphingomonas sp. 2629-1 b, Sphingomonas sp. 2629-3b, and Nocardia sp. 2629-2b, respectively. These new strains are deposited at the International Patent Organism Depository (IPOD) on Jan. 22, 2004 and assigned Sphingomonas sp. 2629-1b FERM P-19641, Sphingomonas sp. 2629-3b FERM P-19643, and Nocardia sp. 2629-2b FERM P-19642, respectively.

The mixture of the microorganisms for assimilating waste oils, fats or organic waste materials, etc. according to the present invention comprises a mixture of strain or strains of the microorganism belonging to genus Nocardia with a strain or strains of the microorganism belonging to genus Sphingomonas and/or the microorganism belonging to genus Microbacterium and/or the microorganism belonging to genus Bacillus, each capable of growing in a waste liquid containing waste oils, fats or organic waste materials, etc., by assimilating the waste oils or fats, etc. contained therein and growing therein.

As the strain belonging to genus Nocardia capable of assimilating waste oils or fats, etc., contained in a waste liquid, there may be used, for example, Nocardia sp. 2629-2b FERM P-19642. In addition, there may also be used other strains belonging to genus Nocardia other than the above Nocardia strain.

In accordance with the present invention, the other microorganism or microorganisms for assimilating oils or fats, etc. to be used as a mixture of the microorganism may comprise a strain or strains belonging to genus Sphingomonas, including, but being not limited to, Sphingomonas sp. 2629-1b (FERM P-19641), Sphingomonas sp. 2629-3b (FERM P-19643), and Sphingomonas sp. SIID 440-2 (FERM P-17975). These strains for assimilating oils or fats, etc. are described in the above prior art (Japanese Patent No. 3,400,418) and identified and deposited by the present inventors at the above depository (IPOD).

Further, the other microorganisms for assimilating oils or fats, etc. to be used as the microorganism mixture according to the present invention may comprise strains belonging to genus Microbacterium, including, but being not limited to, Microbacterium saperdae SIID 440-1 (FERM P-17974) and Microbacterium esteraromaticum SIID 440-3 (FERM P-17976). These strains are each the microorganism for assimilating oils or fats, etc., described in the above prior art (Japanese Patent No. 3,400,418) and identified and deposited by the present inventors at the above depository (IPOD).

Moreover, the other microorganisms for assimilating oils or fats, etc. to be used as the mixture of the microorganisms according to the present invention may comprise strains belonging to genus Bacillus, including, but being not limited to, Bacillus cereus SIID 440-4 (FERM P-17977). These strains are each the microorganism for assimilating oils or fats, etc. described in the above prior art (Japanese Patent No. 3,400,418) and are identified by the present inventors at the above depository (IPOD).

A mixture ratio of the mixture of the microorganisms for assimilating oils or fats, etc. according to the present invention may vary with the purpose or mode of usage, and they may be mixed each at an equal rate or at any rate larger or smaller than the other. The mixture of the microorganisms for assimilating oils or fats, etc. can provide great merits because it has an extremely high ability of assimilation of waste oils, fats or organic waste materials, etc. contained in a waste liquid and an excellent reproducibility, and it can be controlled with ease.

As a one embodiment in accordance with the present invention, the mixture of the microorganisms for assimilating oils or fats, etc. may be formulated, for example, by adding the given microorganisms for assimilating oils or fats, etc. to a culture mixture in equal quantities and incubating the resulting mixture in a liquid broth culture medium (containing hot water extracts of fish and pork meats: 50 grams/liter) at 15° C.-20° C. under aerobic conditions by means of aeration by adding air at a rate of 60 milliliters per cubic meter at every minute up to a stationary phase (for seven days). Upon a practical application, the culture mixture may better be used portionwise after removal of solid materials by filtering.

The present invention will be described hereinafter in more details by way of examples.

### EXAMPLE 1

A soil sample was collected in Oita city, Oita Prefecture, Japan and a sludge sample was collected from a drainageway in Oita city, Oita Prefecture, Japan. A certain quantity of each of the samples was added to a 500-liter vessel containing a liquid broth culture medium consisting of a culture mix and diluted with hot water extracts of fish and pork meats (50 grams/liter). Thereafter, the culture medium was incubated continually at 15° C.-20° C. for two years under aerobic conditions (by aeration by adding air at a rate of 60 liters per cubic meter per minute), thereby selecting the microorganisms capable of assimilating oils or fats, etc. having the given properties and finally acquiring the strains of plural microorganisms capable of efficiently decomposing the waste oils or fats, etc. contained therein. In this example, the incubation was carried out under circumstances closer to actual in situ conditions of a grease trap.

### EXAMPLE 2

The culture mix consisting of the new microorganisms selected in Example 1 was diluted and coated on a nutrient agar culture medium, and the microorganisms were grown on the culture medium. Then, single colonies were separated from the culture medium and three kinds of microorganisms were detected on the basis of their microbiological properties and identified as strains 2629-1b, 2629-2b, and 2629-3b.

These strains were collected from the culture medium and mixed at equal quantities to give a culture mix, and the culture mix of the three strains of the respective microorganisms was found capable of efficiently decomposing waste oils and fats, etc. These strains were investigated for their bacteriological properties in accordance with the experimental procedures as disclosed in the Bergey's Manual of Systematic Bacteriology, 8th Edition. The bacteriological properties of the strains will be illustrated in Table 1.

TABLE 1

| | | Strain | Strain | Strain |
|---|---|---|---|---|
| Experimental Items | | 2629-1b | 2629-2b | 2629-3b |
| Incubation Temp. | | 30° C. | 30° C. | 30° C. |
| Shape of cell | | Rod | Rod | Rod |
| Size of cell (mm) | | 0.6-0.7 × | 0.7-0.8 × | 0.6-0.7 × |
| | | 1.5-2.0 | 1.5-3.0 | 2.0-3.0 |
| Gram-staining | | Negative | Positive | Negative |
| Spore | | − | − | − |
| Mobility | | + | − | − |
| Colony | Medium | Nutrient agar | Nutrient agar | Nutrient agar |
| | Culture time | 24 hours | 24 hours | 24 hours |
| | Diameter | <1.0 mm | <1.0 mm | <1.0 mm |
| | Color | Yellow | Cream | Yellow |
| | Shape | Round | Round | Round |
| | Swollen shape | Lens-shaped | Semispherical | Lens-shaped |
| | Peripheral edge | Entire edge | Filament- | Entire edge |
| | | | shaped | |
| | Surface shape | Smooth | Rough | Smooth |
| | Transparency | Semi-opaque | Opaque | Semi-opaque |
| | Consistency | Butter-like | Dry | Butter-like |
| Culture | 37° C. | + | + | + |
| Temp. | 45° C. | − | − | − |

| | | | |
|---|---|---|---|
| Catalase | + | + | + |
| Oxidase | + | − | + |
| Acid/gas production | −/− | −/− | −/− |
| (glucose) | | | |
| O/F test (glucose) | −/− | −/− | −/− |
| Classification group | Coryneform | Coryneform | Sphingomonas |
| indicating similar shape | bacterium | bacterium | |

Notes:
+: positive;
−: negative

These microorganisms were classified and identified by the analysis of the partial base sequence of their 16SrDNAs. The genomic DNA was extracted from these strains by using PrepMan™ Method (Applied Biosystems, U.S.). An approximate 500 bp region of the 5′-terminus of the 16SrDNA was amplified by means of PCR method by using the extracted DNA. Thereafter, the amplified base sequence was subjected to sequencing and analysis. The purification and the cyclic sequencing of the PCR product were conducted by using MicroSeq™ 500 16SrDNA Bacterial Sequencing Kit (Applied Biosystems, U.S.). The operations in the course from the extraction of the genomic DNA to the cyclic sequencing were carried out in accordance with a protocol (P/N 4308132 Rev. A: Applied Biosystems, U.S.). In this protocol, a thermal cycler used was GeneAmP® PCR System 9600 (Applied Biosystems, U.S.) and a DNA sequencer used was ABI PRISM® 377 DNA Sequencer (Applied Biosystems, U.S.).

A search for homology and the formation of a taxonomic tree were carried out using the base sequence of the 16SrDNA acquired, and a review was made about neighboring species of these strains and about a classification group to which they belong. The search for homology and the formation of the taxonomic tree were carried out by using MicroSeq™ Microbial Identification System Software V. 1.4 and MicroSeq™ Bacterial 500 Library v.0023 (Applied Biosystems, U.S.), respectively. Upon analysis, the search for the homology was effected using the base sequence of the acquired 16SrDNA, and ten strains were determined which had ten highest homology ratios. Further, by using the 16SrDNAs of the ten strains having the highest homology ratios and a sample, a molecular taxonomic tree was formed by means of the neighboring connection method (Saitou and Nei, Mol. Biol. Evol., 1987 4:406-425), and a review was made about the neighboring species of the sample and a group of classification to which it belongs. Moreover, if no strain with a 100% homology were found by the search with MicroSeq™ Bacterial 500 Library, a search for homology was carried out regarding DNA base sequence database (GenBank/EMBL/DDBJ) using BLAST (Altschul et al., Nucleic Acids Res. 1997 25:3389-3402).

### EXAMPLE 3

### Determination of Partial Base Sequence of 16SrDNA of Strain 2629-1b (SEQ ID #1)

As a result of analysis with MicroSeq™, it was found that the partial base sequence of the 16SrDNA of the strain 2629-1b indicated the highest homology as high as 97.66% to Sphingomonas adhaesiva (Int. J. Syst. Bacteriol. 1990 40:320-321). It is also indicated that the 16SrDNA of the strain 2629-1b is contained in a cluster which is formed by the 16SrDNA of Sphingomonas and it formed a cluster with the 16SrDNA of Sphingomonas echinoids (Dinner et al., Int. J. Syst. Bacteriol. 1962 49:1103-1109). Further, as a result of a homology search for GenBank/EMBL/DDBJ using BLAST, the 16SrDNA of the strain 2629-1b was found to have the highest homology as high as 98.1% to the 26SrDNA of a strain (uncultured bacterium Accession No. AF443570). Moreover, it was found that the 16SrDNA of the strain 2629-1b indicated a 99.1% homology to the 16SrDNA of Sphingomonas koreensis JSS-26 (a standard strain) (Lee et al., 2001 51:1491-1498). The above results suggest that the strain 2629-1b belongs to a species close to the standard strain of Sphingomonas koreensis, but it does not thoroughly agree to the standard strain thereof. As a result, the strain 2629-1b was determined as a Sphingomonas sp.

In addition, the partial base sequence of the 16SrDNA of Sphingomonas sp. 2629-1b (FERM P-19641) was compared with that of Sphingomonas sp. SIID 440-2 (FERM P-17975) that is a strain belonging to the same genus Sphingomonas, as disclosed in Japanese Patent No. 3,400,418. As a result, it was found that the strain Sphingomonas sp. 2629-1b (FERM P-19641) was different from the strain Sphingomonas sp. SIID 440-2 (FERM P-17975).

Furthermore, it was found from the properties and the analysis of the base sequence of the 16SrDNA that the strain Sphingomonas sp. 2629-1b (FERM P-19641) was different from Sphingomonas capsulate (Japanese Patent Application Publication No. 2003-250,527) and Sphingomonas paucimobilis (Japanese Patent Application Publication No. 11-46,756). It is known that Sphingomonas capsulate is capable of decomposing polyvinyl alcohol which is a noxious substance and Sphingomonas paucimobilis is capable of decomposing pollutants containing petroleum products. Moreover, the analysis of the base sequence of the 16SrDNA indicates that the strain Sphingomonas sp. 2629-1b (FERM P-19641) was different from any known Sphingomonas strains.

In addition, like the strain Sphingomonas sp. 2629-1b (FERM P-19641), the strain Sphingomonas sp. 2629-3b (FERM P-19643) was likewise different from any known Sphingomonas strains.

### EXAMPLE 4

### Determination of Partial Base Sequence of 16SrDNA of Strain 2629-2b (SEQ ID #2)

As a result of analysis with MicroSeq™, it was found that the partial base sequence of the 16SrDNA of the strain 2629-2b indicated the highest homology as high as 99.2% to Nocardia asteroides (Skennan et al., Int. J. Syst. Bacteriol. 1980 30:225-420). It was also indicated in a molecular taxonomic tree that the 16SrDNA of the strain 2629-2b formed a cluster with the 16SrDNA of Nocardia asteroides. Further, it was found as a result of a homology search for GenBank/EMBL/DDBJ using BLAST that the 16SrDNA of the strain 2629-2b had the highest homology as high as 99.4% to the 16SrDNA of standard strains, i.e., Nocardia asteroides ATCC 19247 and DSM 43757. It was decided from the above results that the strain 2629-2b was a species belonging to genus Nocardia and identified as Nocardia sp 2629-2b.

### EXAMPLE 5

### Determination of Partial Base Sequence of 16SrDNA of Strain 2629-3b (SEQ ID #3)

As a result of analysis with MicroSeq™, it was found that the partial base sequence of the 16SrDNA of the strain 2629-3b indicated the highest homology as high as 99.58% to Sphingomonas macrogoltabidus (Int. J. Syst. Bacteriol. 1993 43:864-865). It is also indicated in a molecular taxonomic tree that the 16SrDNA of the strain 2629-3b formed a cluster with the 16SrDNA of Sphingomonas macrogoltabidus. Further, as a result of a homology search for GenBank/EMBL/DDBJ using BLAST, the 16SrDNA of the strain 2629-3b was found to have the highest homology as high as 99.4% to the 16SrDNA of strain Sphingomonas chilensis S37. Moreover, it was found that the 16SrDNA of the strain 2629-3b indicated a 99.1% homology to the 16SrDNA of a standard strain, Sphingomonas macrogoltabidus IFO 15033. It was decided from the above results that the strain 2629-3b was determined as a Sphingomonas sp.

In addition, the partial base sequence of the 16SrDNA of Sphingomonas sp. 2629-3b (FERM P-19643) was compared with that of the strain Sphingomonas sp. SIID 440-2 (FERM P-17975) that is a strain belonging to the same genus Sphingomonas, as disclosed in Japanese Patent No. 3,400,418. As a result, it was found that the strain Sphingomonas sp. 2629-3b (FERM P-19643) was different from the strain Sphingomonas sp. SIID 440-2 (FERM P-17975).

### EXAMPLE 6

In order to study the ability of decomposing waste oils or fats, etc. for a mixture of the strains Sphingomonas sp. 2629-1b (FERM P-19641), Nocardia sp. 2629-2b (FERM P-19642), and Sphingomonas sp. 2629-3b (FERM P-19643), these strains were each multiplied in a liquid broth culture medium (containing hot water extracts of fish and pork meats: 500 grams per liter) up to its stationary phase, and each of the culture mixtures was then measured for a BOD (Biological Oxygen Demand) value and an amount of n-hexane extracts. Then, each culture mixture (500 ml) was added to a grease trap and in 24 hours after addition, it was measured for a BOD value and an amount of n-hexane extracts. The BOD value was measured in accordance with JIS (Japanese Industrial Standards) KO 102-21 and the amount of n-hexane extracts was measured in accordance with JIS KO102-243. As results of measurements, it was found that the addition of each strain culture mixture decreased the BOD value and the amount of the n-hexane extracts to 0.1% or lesser in each case, as compared with cases where no strain culture mixture was added.

The seven strains, i.e., Sphingomonas sp. 2629-1b (FERM P-19641), Sphingomonas sp. 2629-3b (FERM P-19643), Sphingomonas sp. SIID 440-2 (FERM P-17975), Nocardia sp. 2629-2b (FERM P-19642), Microbacterium saperdae SIID 440-1 (FERM P-17974), Microbacterium esteraromaticum SIID 440-3 (FERM P-17976), and Bacillus cereus SIID 440-4 (FERM P-17977), were each added in an equal amount to a liquid broth culture medium (containing hot water extracts of fish and pork meats: 500 grams per liter) and the culture medium was incubated for seven days at 15° C.-20° C. under aerobic conditions by aeration (by a supply of air at a rate of 60 liters per minute per cubic meter) up to a stationary phase. It was found from the results that the addition of the seven different kinds of the strains decreased the BOD value and the amounts of the n-hexane extracts to 0.1% or lesser, with respect to cases when no strain culture mixture was added.

### EXAMPLE 7

An experiment was carried out for decomposing waste oils, fats and organic waste materials, etc. in drainage from a kitchen of a restaurant (having an average daily meal supply capacity of approximately 500 meals) by adding the mixture of the microorganisms for assimilating waste oils and fats, etc. according to the present invention to a grease trap equipped at the restaurant.

The grease trap used in this experiment was a conventional one having a disposal vessel with three sections. Each section had a capacity of 1-1.5 cubic meter and was provided with a diffusing nozzle connected to a pump. In the first section of the vessel, a culture mixture of the above microorganisms was incubated by aeration at the rate of 60 liters per minute per cubic meter. In the second section, the culture mixture was transferred from the first section to the second section and continually incubated in the same way as in the first section in order to decompose and assimilate the remaining waste oils and fats, etc. The third section was a preliminary section, and the culture mixture (100 ppm-1,000 ppm: 50 ml) was mixed together with water from a sink to the grease trap every day after work was finished. An automatic apparatus was equipped to the grease trap so as to enable a constant amount of the culture mixture to be added thereto at a constant time.

The drainage from the grease trap was then measured for the BOD value and the amounts of the n-hexane extracts before and after treatment with the microorganisms. The BOD value was measured in accordance with JIS K0102-21 and the n-hexane extracts were measured in accordance with JIS KO102-243.

Table 2 below shows the results obtained in one of experiments which were carried out in a similar way at fifty different facilities. It was also found that similar results were obtained in those experiments where the strains of interest were multiplied in a grease trap and mixed at a ratio varied to a great extent due to environmental conditions such as nutritional conditions and so on, followed by dilution with a large quantity of drainage and addition of the culture mixture everyday.

TABLE 2

| | BOD Value (mg/ml) | n-hexane extracts (mg/ml) |
|---|---|---|
| Before addition | 98,540 | 320,400 |
| After 12 hours | 4,560 | 320 |
| After 24 hours | 450 | 45 |
| After 48 hours | 320 | 40 |
| No addition | 89,430 | 334,030 |

The amount of a culture mixture containing the microorganisms for assimilating oils or fats, etc. to be added maybe preferably varied in accordance with kinds and/or amounts of the oils, fats or organic materials, etc. contained in the culture mixture, in particular when the culture mixture is added to a combined sewage vessel, an industrial disposal plant, a sewage disposal plant, or the like.

### EXAMPLE 8

### Preparation of Culture Mixture Containing a Mixture of Microorganisms (for a Deodorizing Microorganism Preparation)

Three kinds of strains, Sphingomonas sp 2629-1b (FERM P-19641), Sphingomonas sp 2629-3b (FERM P-19643) and Nocardia sp 2629-2b (FERM P-19642), were mixed at equal quantities (1-4×10⁶ cells/ml) to a liquid broth culture medium (containing hot water extracts of fish and pork meats: 50 grams per liter) and incubated for seven days at 25° C. by aeration at the rate of 60 liters per minute per cubic meter. The resulting culture medium was then filtered to form a culture mixture containing a mixture of the microorganisms as a deodorizing microorganism preparation.

### EXAMPLE 9

### Test for Deodorizing Offensive Odors

Measurements for a concentration of methyl mercaptan, trimethylamine, ammonia and hydrogen sulfide, all being causes of offensive odors, were conducted in substantially the same manner as in Example 7 before and after treatment with the resulting mixture of the microorganisms by means of a grease trap equipped at a kitchen at each of two locations in Oita Prefecture, Japan. The measurements revealed that these compounds decreased below the limit of detection at each location after treatment.

### EXAMPLE 10

### Perception Test

It was confirmed that the above compounds causing offensive odors could be decomposed as in the above-described case where the compounds were present in large quantities as in Example 9. On the other hand, a very small quantity of a compound or compounds causing offensive odors may become a big concern at a source where offensive odors are generated, and it is difficult to detect such a small quantity of the compound in question with a currently available measurement device. Therefore, in many cases, the detection often depends on a human perception so that, in this example, the deodorizing effect was measured by a perception test. The results of the perception test for detecting offensive odors were assessed by six ratings as will be described below.

S0: No odors were perceived.

S1: Odors were perceived very faintly.

S2: Weak, but distinctive odors were perceived.
S3: Odors were perceived clearly.

S4: Strong odors were perceived.

S5: Very strong odors were perceived.

In order to confirm the deodorizing effect of the deodorizing microorganism preparation obtained in Example 8, the above perception test were carried out by ten healthy volunteers. The test results are shown in Table 3 below.

TABLE 3
Results of perception test

| | | Degree of perception of | | | | | |
|---|---|---|---|---|---|---|---|
| Kind of | | odors (numbers of volunteers) | | | | | |
| Malodors | Deodorizer | S0 | S1 | S2 | S3 | S4 | S5 |
| Kitchen of | Not used | 0 | 0 | 0 | 0 | 0 | 10 |
| Restaurant A | Microbial | 9 | 1 | 0 | 0 | 0 | 0 |
| | deodorizer | | | | | | |
| | Boiled Microbial | 0 | 0 | 0 | 0 | 0 | 10 |
| | deodorizer | | | | | | |
| Kitchen of | Not used | 0 | 0 | 0 | 0 | 0 | 10 |
| Restaurant B | Microbial | 8 | 2 | 0 | 0 | 0 | 0 |
| | deodorizer | | | | | | |
| | Boiled Microbial | 0 | 0 | 0 | 0 | 0 | 10 |
| | deodorizer | | | | | | |

The results of the perception test as shown in Table 3 above revealed that a thorough removal of the offensive odors has been confirmed when the deodorizing agent comprising the mixture of the microorganisms according to the present invention was used.

It can also be noted herein that the culture liquid containing the mixture of the three microorganisms presented the highest effects for deodorizing offensive odors, although each of the three microorganisms, i.e., Sphingomonas sp 2629-1b (FERM P-19641), Sphingomonas sp 2629-3b (FERM P-19643) and Nocardia sp 2629-2b (FERM P-19642), could also exhibit the odorizing effect.

The perception tests for the culture liquids containing the mixture of the microorganisms according to the present invention were carried out in substantially the same manner for pet animals such as dogs and cats, toilettes, kitchens, grease traps, sewage disposal vessels, poultry- and livestock-feeding facilities, and so on at more than 100 locations in prefectures of Oita, Fukuoka, Kumamoto, Nagasaki, Hiroshima, Okayama and Tokyo, Japan. As a result, it was found that offensive odors generated from such facilities were removed to an effective extent.

### INDUSTRIAL APPLICABILITY

In accordance with the present invention, the microorganisms for assimilating oils, fats or an organic waste material contained in a waste liquid can decompose the waste oils, fats or organic waste materials contained in the waste liquid and reduce a BOD value and an amount of n-hexane extracts. The microorganisms comprise Sphingomonas sp 2629-1b (FERM P-19641) or Sphingomonas sp 2629-3b (FERM P-19643) and Nocardia sp 2629-2b (FERM P-19642) or a mixture of a microorganism belonging to genus Nocardia and capable of growing by assimilation of waste oils, fats or organic waste materials, etc. as well as a microorganism belonging to genus Sphingomonas and/or genus Microbacterium and/or genus Bacillus, each capable of growing by assimilation of waste oils, fats or an organic waste material, etc. contained in a waste liquid particularly discharged from domestic or industrial kitchens, etc.

What is claimed is:

1. A microorganism for assimilating oils, fats or an organic waste material, etc., wherein said microorganism comprises Sphingomonas sp 2629-1b (FERM P-19641) or Sphingomonas sp 2629-3b (FERM P-19643), each belonging to genus Sphingomonas and capable of growing by assimilation of waste oils, fats or an organic waste material, etc.

2. A microorganism for assimilating oils, fats or an organic waste material, etc., comprising a microorganism belonging to genus Nocardia and capable of growing by assimilation of waste oils, fats or an organic waste material, etc.

3. The microorganism for assimilating oils, fats or an organic waste material, etc. as claimed in claim 2, wherein said microorganism comprises Nocardia sp 2629-2b (FERM P-19642).

4. A mixture of microorganisms for assimilating oils, fats or an organic waste material, etc., comprising a microorganism belonging to genus Nocardia and capable of growing by assimilation of waste oils, fats or an organic waste material, etc. as well as a microorganism belonging to genus Sphingomonas and/or genus Microbacterium and/or genus Bacillus, each capable of growing by assimilation of waste oils, fats or an organic waste material, etc.

5. The mixture of microorganisms for assimilating oils, fats or an organic waste material, etc. as claimed in claim 4, said microorganism belonging to genus Nocardia comprises Nocardia sp 2629-2b (FERM P-19642).

6. The mixture of microorganisms for assimilating oils, fats or an organic waste material, etc. as claimed in claim 4, said microorganism belonging to genus Sphingomonas comprises Sphingomonas sp 2629-1b (FERM P-19641) and/or Sphingomonas sp 2629-3b (FERM P-19643) and/or Sphingomonas sp. SIID 440-2 (FERM P-17975).

7. The mixture of microorganisms for assimilating oils, fats or an organic waste material, etc. as claimed in claim 4, said microorganism belonging to genus Microbacterium comprises Microbacterium saperdae SIID 440-1 (FERM P-17974) and/or Microbacterium esteraromaticum SIID 440-3 (FERM P-17976).

8. The mixture of microorganisms for assimilating oils, fats or an organic waste material, etc. as claimed in claim 4, said microorganism belonging to genus Bacillus comprises Bacillus cereus SIID 440-4 (FERM P-17977).

9. A method for treating a waste liquid comprising decomposing the waste oils, fats or organic waste material, etc. contained in the waste liquid with said microorganism as claimed in claim 1.

10. A method for treating a waste liquid comprising decomposing the waste oils, fats or organic waste material, etc. contained in the waste liquid with said microorganism as claimed in claim 2.

11. A method for treating a waste liquid comprising decomposing the waste oils, fats or organic waste material, etc. contained in the waste liquid with said microorganism as claimed in claim 3.

12. A method for treating a waste liquid comprising decomposing the waste oils, fats or organic waste material, etc. contained in the waste liquid with said mixture of microorganisms as claimed in claim 4.

13. A method for treating a waste liquid comprising decomposing the waste oils, fats or organic waste material, etc. contained in the waste liquid with said mixture of microorganisms as claimed in claim 5.

14. A method for treating a waste liquid comprising decomposing the waste oils, fats or organic waste material, etc. contained in the waste liquid with said mixture of microorganisms as claimed in claim 6.

15. A method for treating a waste liquid comprising decomposing the waste oils, fats or organic waste material, etc. contained in the waste liquid with said mixture of microorganisms as claimed in claim 7.

16. A method for treating a waste liquid comprising decomposing the waste oils, fats or organic waste material, etc. contained in the waste liquid with said mixture of microorganisms as claimed in claim 8.

17. A waste disposal preparation for decomposing waste oils, fats or an organic waste material contained in a waste liquid, comprising a microorganism for assimilating oils or fats, etc., wherein said microorganism comprises Sphingomonas sp 2629-1b (FERM P-19641) or Sphingomonas sp 2629-3b (FERM P-19643), each belonging to genus Sphingomonas and capable of growing by assimilation of waste oils, fats or an organic waste material, etc.

18. The waste disposal preparation as claimed in claim 17, further comprising the microorganism belonging to genus Nocardia and capable of growing by assimilation of waste oils, fats or an organic waste material, etc.

19. The waste disposal preparation as claimed in claim 17, further comprising the microorganism is Nocardia sp 2629-2b (FERM P-19642).

20. A waste disposal preparation for decomposing waste oils, fats or an organic waste material contained in a waste liquid, comprising a mixture of microorganisms for assimilating oils or fats, etc., which comprise a microorganism belonging to genus Nocardia and capable of growing by assimilation of waste oils, fats or an organic waste material, etc. as well as a microorganism belonging to genus Sphingomonas and/or genus Microbacterium and/or genus Bacillus, each capable of growing by assimilation of waste oils, fats or an organic waste material, etc.

21. The waste disposal preparation as claimed in claim 20, wherein the mixture of microorganisms comprises Nocardia sp2629-2b (FERM P-19642) and/or Sphingomonas sp 2629-1b (FERM P-19641) and/or Sphingomonas sp 2629-3b (FERM P-19643) and/or Sphingomonas sp. SIID 440-2 (FERM P-17975) and/or Microbacterium saperdae SIID 440-1 (FERM P-17974) and/or Microbacterium esteraromaticum SIID 440-3 (FERM P-17976) and/or Bacillus cereus SIID 440-4 (FERM P-17977).

22. A deodorizing preparation for deodorizing offensive odors generating from a waste liquid, comprising a microorganism for assimilating oils or fats, etc., wherein said microorganism comprises Sphingomonas sp 2629-1b (FERM P-19641) or Sphingomonas sp 2629-3b (FERM P-19643), each belonging to genus Sphingomonas and capable of growing by assimilation of waste oils, fats or an organic waste material, etc.

23. The deodorizing preparation as claimed in claim 22, comprising the microorganism belonging to genus Nocardia and capable of growing by assimilation of waste oils, fats or an organic waste material, etc.

24. The deodorizing preparation as claimed in claim 22, comprising the microorganism is Nocardia sp 2629-2b (FERM P-19642).

25. A deodorizing preparation for deodorizing offensive odors generating from a waste liquid, comprising a mixture of microorganisms for assimilating oils or fats, etc., comprising a microorganism belonging to genus Nocardia and capable of growing by assimilation of waste oils, fats or an organic waste material, etc. as well as a microorganism belonging to genus Sphingomonas and/or genus Microbacterium and/or genus Bacillus, each capable of growing by assimilation of waste oils, fats or an organic waste material, etc.

26. The deodorizing preparation as claimed in claim 25, wherein the mixture of microorganisms comprises Nocardia sp 2629-2b (FERM P-19642) and/or Sphingomonas sp 2629-1b (FERM P-19641) and/or Sphingomonas sp 2629-3b (FERM P-19643) and/or Sphingomonas sp. SIID 440-2 (FERM P-17975) and/or Microbacterium saperdae SIID 440-1 (FERM P-17974) and/or Microbacterium esteraromaticum SIID 440-3 (FERM P-17976) and/or Bacillus cereus SIID 440-4 (FERM P-17977).

27. A method for deodorizing offensive odors generating from a waste liquid, comprising decomposing waste oils, fats or an organic waste material contained in with a microorganism for assimilating oils or fats, etc., wherein said microorganism comprises Sphingomonas sp 2629-1b (FERM P-19641) or Sphingomonas sp 2629-3b (FERM P-19643), each belonging to genus Sphingomonas and capable of growing by assimilation of waste oils, fats or an organic waste material, etc.

28. The method as claimed in claim 27, comprising the microorganism belonging to genus Nocardia and capable of growing by assimilation of waste oils, fats or an organic waste material, etc.

29. The method as claimed in claim 27, comprising the microorganism is Nocardia sp 2629-2b (FERM P-19642).

30. A method for deodorizing offensive odors generating from a waste material comprising a mixture of microorganisms for assimilating oils or fats, etc., comprising a microorganism belonging to genus Nocardia and capable of growing by assimilation of waste oils, fats or an organic waste material, etc. as well as a microorganism belonging to genus Sphingomonas and/or genus Microbacterium and/or genus Bacillus, each capable of growing by assimilation of waste oils, fats or an organic waste material, etc.

31. The method as claimed in claim 30, wherein the mixture of microorganisms comprises Nocardia sp 2629-2b (FERM P-19642) and/or Sphingomonas sp 2629-1b (FERM P-19641) and/or Sphingomonas sp 2629-3b (FERM P-19643) and/or Sphingomonas sp. SIID 440-2 (FERM P-17975) and/or Microbacterium saperdae SIID 440-1 (FERM P-17974) and/or Microbacterium esteraromaticum SIID 440-3 (FERM P-17976) and/or Bacillus cereus SIID 440-4 (FERM P-17977).


SEQUENCE LISTING (3 sequences)

SEQ ID NO: 1 - DNA, 471 bp, Sphingomonas sp. 2629-1b
tggagagtttgatcctggctcagaatgaacgctggcggcatgcctaacacatgcaagtcgaacgaaggcttcggccttagtggcgcacgggtgcgtaacgcgtgggaatctgcccttgggttcggaataacagttagaaatgactgctaataccggatgatgtcgtaagaccaaagatttatcgcccaaggatgagcccgcgtaggattagctagttggcggggtaaaggcccaccaaggcgacgatccttagctggtctgagaggatgatcagccacactgggactgagacacggcccagactcctacgggaggcagcagtggggaatattggacaatgggcgaaagcctgatccagcaatgccgcgtgagtgatgaaggccttagggttgtaaagctcttttacccgggatgataatgacagtaccgggagaataagctccggctaacttcgtgccagcagccgcggta

SEQ ID NO: 2 - DNA, 500 bp, Nocardia sp. 2629-2b
tggagagtttgatcctggctcaggacgaacgctggcggcgtgcttaacacatgcaagtcgagcggtaaggcccttcggggtacacgagcggcgaacgggtgagtaacacgtgggtgatctgcctcgtacttcgggataagcctgggaaactgggtctaataccggatatgaccttcggmtgcatgtcygwgggtggaaagatttatcggtacgagatgggcccgcggcctatcagcttgttggtggggtaatggcctaccaaggcgacgacgggtagccggcctgagagggcgaccggccacactgggactgagacacggcccagactcctacgggaggcagcagtggggaatattgcacaatgggcgaaagcctgatgcagcgacgccgcgtgagggatgacggccttcgggttgtaaacctctttcgacagggacgaagcgcaagtgacggtacctgtagaagaagcaccggccaactacgtgccagcagccgcggta

SEQ ID NO: 3 - DNA, 471 bp, Sphingomonas sp. 2629-3b
tggagagtttgatcctggctcagaacgaacgctggcggcatgcctaacacatgcaagtcgaacgaagtcttcggacttagtggcgcacgggtgcgtaacgcgtgggaatctgcccttgggtacggaataactcagagaaatttgtgctaataccgtataatgtcttcggaccaaagatttatcgcccaaggatgagcccgcgtaagattagctagttggtggggtaaaagcctaccaaggcgacgatctttagctggtctgagaggatgatcagccacactgggactgagacacggcccagactcctacgggaggcagcagtggggaatattggacaatgggcgaaagcctgatccagcaatgccgcgtgagtgatgaaggccctagggttgtaaagctcttttacccgggatgataatgacagtaccgggagaataagctccggctaactccgtgccagcagccgcggta